(19) United States
(12) Patent Application Publication
(10) Pub. No.: US 2026/0213807 A1
(43) Pub. Date: Jul. 23, 2026

(54) METHODS, DEVICES AND MEDIUM FOR COMMUNICATION

(71) Applicant: NEC Corporation, Tokyo (JP)

(72) Inventors: Zhen HE, Beijing (CN); Peng GUAN, Beijing (CN); Gang WANG, Beijing (CN)

(73) Assignee: NEC Corporation, Tokyo (JP)

(21) Appl. No.: 19/140,607

(22) PCT Filed: Dec. 19, 2022
(86) PCT No.: PCT/CN2022/139989

§ 371 Date: Jun. 18, 2025

(51) Int. Cl. H04B 7/06; H04B 17/318

(52) U.S. Cl. CPC H04B 7/0626; H04B 17/328

(57) ABSTRACT

Embodiments of the present disclosure provide a solution on collisions of CSI reports. A device determines priorities of a first CSI report and a second CSI report based on first type of information associated with the first and second CSI reports. The first and second CSI reports belong to a first type of CSI report. The device determines which CSI report to be transmitted or updated based on the determined priorities. In this way, the collision of the plurality of CSI reports that belong to the first type of CSI report can be solved.

### FIELDS

Example embodiments of the present disclosure generally relate to the field of communication techniques and in particular, to methods, devices, and medium for collisions of channel state information (CSI) reports.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances. For example, a CSI report can be generated based on an AI/ML model. In some situations, a plurality one CSI report may collide. Thus, solutions on solving collisions of CSI reports are needed.

### SUMMARY

In general, embodiments of the present disclosure provide methods, devices and computer storage medium for solving collisions of CSI reports.

In a first aspect, there is provided a device for communication. The device comprises a processor that is configured to cause the device to: determine that a first channel state information (CSI) report and a second CSI report collide, wherein the first and second CSI reports are first type of CSI reports; determine a first priority of the first CSI report based on first type of information associated with the first CSI report; determine a second priority of the second CSI report based on the first type of information associated with the second CSI report, wherein the first type of information comprises at least one of: a set of artificial intelligent/machine learning (AI/ML) related report contents carried by the first and second CSI reports, life cycle management (LCM) related information, model related information, or CSI processing unit (CPU) related information; and determine, from the first and second CSI reports, a CSI report to be transmitted or updated based on the determined first and second priorities.

In a second aspect, there is provided a communication method. The method comprises: determining that a first channel state information (CSI) report and a second CSI report collide, wherein the first and second CSI reports are first type of CSI reports; determining a first priority of the first CSI report based on first type of information associated with the first CSI report; determining a second priority of the second CSI report based on the first type of information associated with the second CSI report, wherein the first type of information comprises at least one of: a set of artificial intelligent/machine learning (AI/ML) related report contents carried by the first and second CSI reports, life cycle management (LCM) related information, model related information, or CSI processing unit (CPU) related information; and determining, from the first and second CSI reports, a CSI report to be transmitted or updated based on the determined first and second priorities.

In a third aspect, there is provided a computer readable medium having instructions stored thereon, the instructions, when executed on at least one processor, causing the at least one processor to carry out the method according to the first, or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of reporting angle information in accordance with some embodiments of the present disclosure;

FIG. 3 illustrates a flowchart of a method implemented at a terminal device according to some example embodiments of the present disclosure; and

FIG. 4 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. The term “Channel State Information (CSI)” used herein may refer to channel properties of a communication link. CSI describes how a signal propagate from the transmitter to the receiver and represents the combined effect of, for example, scattering, fading, and power decay with distance. The term “CSI report” may refer to a report that indicate how good or bad the channel is.

As mentioned above, CSI reports may collide. In some solutions, it may propose collisions of CSI report based on AI/ML model and CSI reports based on non-AI/ML or legacy CSI report. However, the collisions of a plurality of AI CSI reports are not solved yet. Therefore, solutions on the collisions of the plurality of AI CSI reports are needed.

In order to solve at least part of the above problems, embodiments of the present disclosure provide a solution on collisions of CSI reports. A device determines priorities of a first CSI report and a second CSI report based on first type of information associated with the first and second CSI reports. The first and second CSI reports belong to a first type of CSI report. The device determines which CSI report to be transmitted or updated based on the determined priorities. In this way, the collision of the plurality of CSI reports that belong to the first type of CSI report can be solved.

In the context of the presented application, the term “AI/ML model” used herein may refer to a data driven algorithm that applies AI/ML techniques to generate a set of outputs based on a set of inputs. The term “AI/ML model” may be interchangeably with the term “model.” The term “data collection” may refer to a process of collecting data by the network nodes, management entity, or UE for the purpose of AI/ML model training, data analytics and inference. The term “AI/ML model training” used herein may refer to a process to train an AI/ML Model [by learning the input/output relationship] in a data driven manner and obtain the trained AI/ML Model for inference. The term “AI/ML model inference” used herein can refer to a process of using a trained AI/ML model to produce a set of outputs based on a set of inputs.

The term “AI/ML model validation” used herein may refer to a subprocess of training, to evaluate the quality of an AI/ML model using a dataset different from one used for model training, that helps selecting model parameters that generalize beyond the dataset used for model training. The term “model monitoring” used herein may refer to a procedure that monitors the inference performance of the AI/ML model.

The term “UE-side (AI/ML) model” used herein may refer to an AI/ML Model of which inference is performed entirely at the UE. The term “network-side (AI/ML) model” used herein may refer to an AI/ML Model of which inference is performed entirely at the network. The term “one-side (AI/ML) model” used herein may refer to a UE-side (AI/ML) model or a network-side (AI/ML) model. The term “two Two-sided (AI/ML) model” used herein may refer to a paired AI/ML Model(s) over which joint inference is performed, where joint inference includes AI/ML Inference whose inference is performed jointly across the UE and the network, i.e, the first part of inference is firstly performed by UE and then the remaining part is performed by gNB, or vice versa.

The term “model activation” used herein may refer to enabling an AI/ML model for a specific function. The term “model deactivation” used herein may refer to disabling an AI/ML model for a specific function. The term “model switching” used herein may refer to deactivating a currently active AI/ML model and activating a different AI/ML model for a specific function. The term “model management” used herein may refer to a more general term includes one or more of following functions/procedures: model activation, deactivation, selection, switching, fallback, and update (including re-training).

The term “supervised learning” used herein may refer to a process of training a model from input and its corresponding labels. The term “unsupervised learning” used herein may refer to a process of training a model without labelled data. The term “semi-supervised learning” used herein may refer to a process of training a model with a mix of labelled data and unlabelled data. The term “reinforcement Learning (RL)” used herein may refer to a process of training an AI/ML model from input (a.k.a. state) and a feedback signal (a.k.a. reward) resulting from the model's output (a.k.a. action) in an environment the model is interacting with.

Principles and implementations of the present disclosure will be described in detail below with reference to the figures.

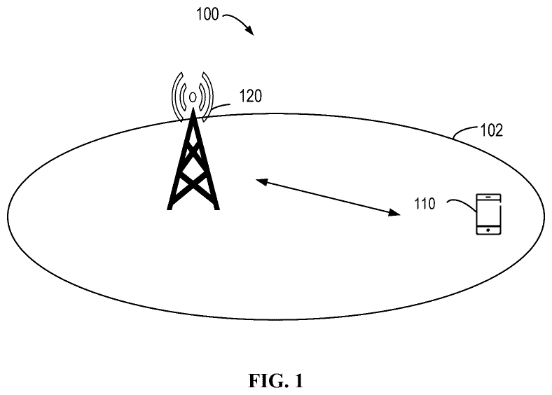

FIG. 1 illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1, the terminal device 110 may be a UE and the network device 120 may be a base station serving the UE. The serving area of the network device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be other device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, if the terminal device 110 is a terminal device and the network device 120 is a network device, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

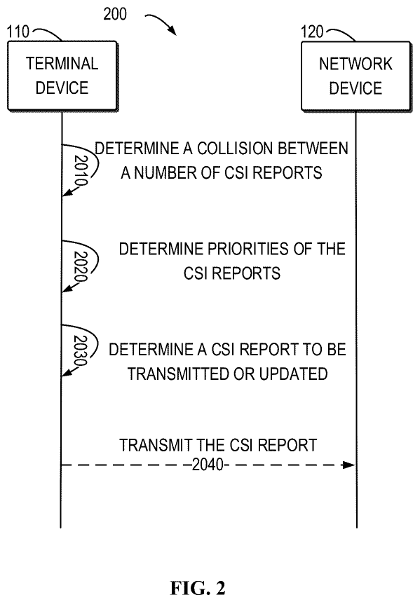

Reference is made to FIG. 2, which illustrates a signaling flow 200 of reporting angle information in accordance with some embodiments of the present disclosure. For the purposes of discussion, the signaling flow 200 will be discussed with reference to FIG. 1, for example, by using the terminal device 110 and the network device 120. It is noted that FIG. 2 is only an example embodiment.

The terminal device 110 determines (2010) a collision between a number of CSI reports, for example, a first CSI report and a second CSI report. It is noted that number of CSI reports may be any suitable number. The first and second CSI reports are first type of CSI reports.

In some embodiments, if the resources for transmitting the first CSI report and the resources for transmitting the second CSI report overlap in time and/or frequency domain, the terminal device 110 may determine that the first CSI report and the second CSI report collide. For example, if time occupancy of physical channels scheduled to carry the first and second CSI reports overlap in at least one OFDM symbol and are transmitted on the same carrier, the first and second CSI reports may collide. Alternatively, if the resources for processing the first CSI report and the resources for processing the second CSI report overlap, the terminal device 110 may determine that the first CSI report and the second CSI report collide. For example, the CSI processing units (CPUs) occupied the first and second CSI reports overlap in at least one OFDM symbol, the first and second CSI reports may collide.

As mentioned above, the first and second CSI reports are the first type of CSI reports. The first type of CSI report may satisfy one or more conditions. For example, a CSI report is associated with a new type (referred to as “first type”) of CSI report, which is different from the type of non-AI CSI report or legacy CSI report. For example, there may be at least 2 types of CSI report: Type 1 and Type 2. Type 1 is different from Type 2, e.g., Type 1 is used to indicate UE needs to update or processed associated/corresponding CSI report based on AI/ML method/function/model. Type 2 is used to indicates UE needs to update or processed associated/corresponding CSI report based on non-AI/ML method/function/model (or legacy method).

In some embodiments, the first type of CSI report may be associated with an AI/ML function or a life cycle management (LCM) component. For example, the first type of CSI report may be configured or indicated for the AI/ML function or the LCM component. By way of example, the first type of CSI report may be configured with one or more of: model inference, model monitoring, model selection, model training/update (for example, online/offline training, supervised/unsupervised/reinforcement learning), data collection for model inference/monitoring/selection/training/update) by using a signaling from the network device 120. The signaling may be one of: radio resource control, medium access control control element (MAC-CE) or downlink control information. In some embodiments, the first type of CSI report may occur during a time duration that is configured for the AI/ML function or the LCM component. In some other embodiments, the uplink resource carrying the first type of CSI report may be configured in the time duration that is configured for the AI/ML function or the LCM component. Alternatively, the first type of CSI report may occur after the terminal device 110 receives a signaling that enables or activating the AI/ML function or the LCM component.

In some other embodiments, the first type of CSI report may be associated with AI/ML model information, for example, model identity (ID). Alternatively, or in addition, the first type of CSI report may be associated with AI/ML functionality information, for example, indication of functionality. The indication of functionality may refer to an indication information that is used to indicate a functionality (e.g., CSI compression, temporal CSI prediction, spatial beam prediction, temporal beam prediction). The first type of CSI report may be associated with one or more of: a list of AI/ML model information or a list of functionality information.

Alternatively, the first type of CSI report may be associated with a reference signal (RS) or a RS set that is configured for AI/ML function or LCM component. The RS may be one or more of: synchronization signal and physical broadcast channel block (SSB), channel state information reference signal (CSI-RS) or sounding reference signal (SRS). In some embodiments, the first type of CSI report may include/carry a set of AI/ML related report contents. Examples of the set of AI/ML related report contents are described later.

The terminal device 110 determines (2020) priorities of the CSI reports based on first type of information. For example, the terminal device 110 may determine a first priority of the first CSI report based on the first type of information associated with the first CSI report. The terminal device 110 may determine a second priority of the second CSI report based on the first type of information associated with the second CSI report. By way of example, if a CSI report has lower priority value than other CSI reports, the CSI report may have higher priority than other CSI reports. If a CSI report has higher priority than other CSI reports, the terminal device 110 may give priority to send the CSI report, or the terminal device 110 may not transmit the other CSI reports, or the terminal device 110 may drip the other CSI reports. In some embodiments, the first type of information may be related to AI/ML information.

In some embodiments, the first type of information may include periodicity information, for example, aperiodic (AP), semi-persistent (SP) based on physical uplink shared channel (PUSCH), SP based on PUSCCH, or period. The first type of information may also include one or more of: a serving cell index or a report configuration ID.

In some embodiments, the set of AI/ML related report contents may include one or more of: a first set of report contents related to model inference, a second set of report contents related to model monitoring, a third set of report contents related to model training, or a fourth set of report contents related to model update. Alternatively, the set of AI/ML related report contents may include one or more of: a fifth set of report contents to be input of an AI/ML model or a sixth of report contents to be output of an AI/ML model.

In some embodiments, the first type of information may include the set of AI/ML related report contents carried by the CSI report. For example, the set AI/ML related report contents may include one or more of: a set of compressed bits, a first indication of an AI/ML model, a second indication of a functionality, a CSI with a resolution exceeding a threshold (for example, high resolution CSI), a performance metric, a third indication concerning whether the performance metric satisfies a condition, a fourth indication concerning whether is a training or data collection stage of an AI/ML model completed, a predicted CSI, a fifth indication of at least one of the followings: model deactivation, model activation, model switching, model selection, or fallback, assistance information associated with at least one of: beam or the device, or first information comprises at least one of: a probability for a predicted beam to be the best beam, a confidence level for the predicted beam to be the best beam, a beam application time, a predicted beam failure. In some embodiments, the assistance information associated with at least one of beam or the device may include at least one of: a receiving beam identity, a receiving beam angle, receiving beam shape information, an identity or angle of an expected receiving beam, position information of the device, direction information of the device, orientation information of the device, or speed information of the device. A beam of a target signal may refer to a quasi co-location (QCL) RS (for example, QCL-typeD RS) of the target signal. Table 1 to Table 6 show examples of AI/ML related report contents.

Table 1 shows examples related to CSI compression with two-sided model.

TABLE 1

| | | | Model training/update | | | |
|---|---|---|---|---|---|---|
| | Model monitoring | | Training collaborationType1 | | Training collaboration Type3 | |
| Model | NW-side | UE-side | (joint training) | | (separate/sequential training) | |
| inference | monitoring | monitoring | NW-sided model | UE-sided model | NW-first | UE-first |
| Compressed bits | Report | Performance | High | Indication of | High | Report |
| (i.e., output of CSI | 12 nforma | metric | resolution | completion/incompletion | resolution | contents |
| generation part) | listed in | Indication | CSI | of data collection/model | CSI | listed in |
| Indication of model | Model | of indicating | | training/model update | | Model |
| (e.g., model ID), list | inference | whether the | | Indication of | | inference |
| of models, functionality | High | performance | | retransmission/continue | | High |
| Indication of | resolution | metric satisfies | | transmission of data/RS | | resolution |
| compression ratio | CSI | some predefined | | Indication of model | | CSI |
| Indication of | | conditions or | | (e.g., model ID), | | |
| quantization | | thresholds | | model parameters or | | |
| method/codebook/size | | | | functionality of the | | |
| RI | | | | trained/updated model | | |
| LI | | | | Indication of | | |
| CQI | | | | compression ratio | | |
| | | | | Indication of | | |
| | | | | quantization | | |
| | | | | method/codebook/size | | |
| | | | | Indication of | | |
| | | | | scenario/configuration | | |
| | | | | applicable to the | | |
| | | | | trained/updated model | | |

✓ CSI generation part is equivalent to encoder, auto-encoder, or UE-side model.
✓ High resolution CSI includes quantized bits or codebook corresponding to realistic/measured/ground-truth/ideal channel.
✓ Performance metric includes at least one of intermediate KPIs (e.g., SGCS, GCS), eventual KPIs (e.g., throughput, (hypothetical) BLER), metrics reflecting data distribution/drift, comparison results between CSI feedback based on AI/ML and (legacy) CSI feedback based on non-AI/ML, metrics reflecting generalization performance, metrics reflecting CSI feedback overhead or capability/complexity (e.g., FLOPs, model size, number of model parameters)/computation complexity.
✓ Scenario, e.g., deployment scenario (e.g., Uma/Umi/InH), ISD, antenna spacing/virtualization (TxRU mapping), carrier frequency, outdoor/indoor UE distributions, UE speed.
✓ Configuration, e.g., band width, frequency domain granularity, payload size of CSI feedback, layout of antenna port, numerology (e.g., SCS), number of ranks or layers.
✓ The report content for model selection may includes multiple Report contents listed in Model monitoring.

Table 2 shows examples related to temporal CSI prediction with UE-side model.

TABLE 2

| | Model monitoring | | | Model training/update | |
|---|---|---|---|---|---|
| Model | UE-side | NW-side | Hybrid | | |
| inference | monitoring | monitoring | monitoring | UE-side | NW-side |
| Predicted | Indication of | High | Performance | Indication of | High |
| CSI | disabling or | resolution | metric | completion/ | resolution |
| | deactivating | CSI | Indication | incompletion | CSI |
| | AI/ML function | | indicating | of data | Measured |
| | (e.g., temporal CSI | | whether | collection/model | CSI |
| | prediction) or | | the | training/model | |
| | model (e.g., | | performance | update | |
| | current model) | | metric | Indication of | |
| | Indication of | | satisfies | retransmission/ | |
| | model (e.g., new | | some | continue | |
| | model different | | predefined | transmission of | |
| | from the current | | conditions | data/RS | |
| | model) to | | or | Indication of | |
| | switch/activate/ | | thresholds | model | |
| | select | | | (e.g., model ID), | |
| | Indication of | | | model | |
| | information | | | parameters or | |
| | related to input | | | functionality | |
| | and (or) output of | | | of the trained/ | |
| | model to | | | updated model | |
| | switch/activate/ | | | Indication of | |
| | select | | | information | |
| | Indication of | | | related to | |
| | scenario/ | | | input and (or) | |
| | configuration | | | output of the | |
| | applicable to | | | trained/updated | |
| | model to | | | model | |
| | switch/activate/ | | | Indication of | |
| | select | | | scenario/ | |
| | i.e., indication of | | | configuration | |
| | model | | | applicable to the | |
| | deactivation, | | | trained/updated | |
| | switch, | | | model | |
| | reselection, or | | | | |
| | fallback | | | | |

```
✓ Predicted CSI includes at least one of predicted CRI/RI/LI/CQI/PMI/i1, which are
  outputs of the AI/ML model.
✓ Measured CSI includes at least one of CRI/RI/LI/CQI/PMI/i1 measured or
  determined based on realistic/ground-truth channel.
✓ Information related to input/output includes at least one of type/format/size of the
  input/output, measurement/prediction time window and time interval corresponding
  to the input/output.
✓ Performance metric includes at least one of the listed elements in the performance
  metric in Table 1, wherein the intermediate KPIs also include CSI (e.g.,
  CRI/RI/LI/CQI/PMI/i1) prediction accuracy or error.
✓ The report content for model selection may includes multiple Report contents listed
  in Model monitoring.
```

Table 3 shows examples related to spatial beam prediction with NW-side model.

TABLE 3

| Model inference | Model monitoring | Model training/update |
|---|---|---|
| Beam IDs and (or) | Report contents listed in | Report contents in Model |
| measured beam qualities | Model inference | monitoring |
| of all beams in Set B | Beam IDs and (or) | |
| Indication of Set B | measured beam qualities | |
| Indication of number of | of all beams in Set A | |
| beams reported in the CSI | Beam IDs and (or) | |
| report | measured qualities of top | |
| Indication of model (e.g., | N beam(s) in Set A | |
| model ID), model list or | | |
| functionality | | |
| Measured CSI/beam in K | | |
| time instances | | |
| Assistance information | | |

```
✓ Set B refers to a set of beams (i.e., RSs) corresponding to the input of the AI/ML
  model, e.g., the input may be beam IDs and (or) qualities of all beams in Set B.
✓ Set A refers to a set of beams (i.e., RSs) corresponding to the output of the
  AI/ML model, e.g., the output may be beam IDs and (or) qualities of all beams
  in Set B or beam IDs and (or) qualities of top N beam(s) in Set A.
✓ Set B can be a subset of Set A or be different from Set A.
    ✓ N is an integer larger than or equal to 1.
    ✓ Top N beams in Set A refers to the first N beams having the largest beam
      quality in Set A.
✓ Beam ID at least one of CRI, SSBRI.
✓ Beam quality includes at least one of L1-RSRP, L1-SINR.
✓ Assistance information includes at least one of Rx beam ID/angle, Rx beam
  shape information (e.g., Rx beam pattern, Rx beam boresight direction (azimuth
  and elevation), 3Db beamwidth), expected Rx beam for the prediction (e.g.,
  expected Rx angle, Rx beam ID for the prediction), UE position information,
  UE direction information, UE orientation information, UE speed.
✓ The report content for model selection may includes multiple Report contents
  listed in Model monitoring.
```

Table 4 shows spatial beam prediction with UE-side model.

TABLE 4

| | Model monitoring | | | Model training/update | |
|---|---|---|---|---|---|
| Model | UE-side | NW-side | Hybrid | | |
| inference | monitoring | monitoring | monitoring | UE-side | NW-side |
| Beam IDs/ | Indication of | Report | Performance | Indication of | Beam IDs/ |
| angles | disabling or | contents | metric | completion/ | angles |
| and (or) | deactivating | listed in | Indication | incompletion | and (or) |
| predicted | AI/ML function | Model | of | of data | measured |
| beam | (e.g., spatial | inference | indicating | collection/model | beam |
| qualities | beam | Beam | whether | training/model | qualities |
| of top N | prediction) | IDs/ | the | update | of all |
| predicted | or model (e.g., | angles | performance | Indication of | beams in |
| beam(s) | current model) | and (or) | metric | retransmission/ | Set A |
| in Set A | Indication of | measured | satisfies | continue | Beam |
| Other | model (e.g., new | beam | some | transmission | IDs/ |
| information | model different | qualities | predefined | of data/RS | angles |
| | from the current | of all | condition | Indication of | and (or) |
| | model) to | beams in | S or | model | measured |
| | switch/activate/ | Set A | threshold | (e.g., model ID), | qualities |
| | select | Beam | S | model parameters | of top N |
| | Indication of | IDs/ | | or functionality | beam(s) |
| | information | angles | | of the trained/ | in Set A |
| | related to input | and (or) | | updated model | Beam |
| | and (or) output | measured | | Indication of | IDs/angles |
| | of model to | qualities | | information | and (or) |
| | switch/activate/ | of top N | | related to | measured |
| | select | beam(s) | | input and (or) | qualities |
| | Indication of | in Set A | | output of the | of all |
| | scenario/ | Beam | | trained/updated | beam(s) |
| | configuration | IDs/ | | model | in Set B |
| | applicable | angles | | Indication of | Indication |
| | to the | and (or) | | scenario/ | of Set B |
| | trained/updated | measured | | configuration | Indication |
| | model | beam | | applicable to | of |
| | | qualities | | model to | number |
| | | of all | | switch/activate/ | of beams |
| | | beams in | | select | reported |
| | | Set B | | | in the CSI |
| | | Beam | | | report |
| | | IDs/ | | | Indication |
| | | angles | | | of model |
| | | and (or) | | | (e.g., |
| | | measured | | | model |
| | | qualities | | | ID), |
| | | of top N | | | model list |
| | | beam(s) | | | or |
| | | in Set B | | | functiona- |
| | | Indication | | | lity |
| | | of Set B | | | Assistance |
| | | Indication | | | information |
| | | of number | | | |
| | | of beams | | | |
| | | reported | | | |
| | | in the CSI | | | |
| | | report | | | |
| | | Indication | | | |
| | | of model | | | |
| | | (e.g., | | | |
| | | model | | | |
| | | ID), | | | |
| | | model list | | | |
| | | or | | | |
| | | functiona- | | | |
| | | lity | | | |

```
✓ Other information includes at least one of probability for the beam to be the beast
  beam, or associated confidence for the beam to be the best beam.
✓ Information related to input/output includes at least one of type/format/size of the
  input/output (e.g., beam pattern or beam IDs corresponding to the beams in Set B or
  Set A).
✓ Performance metric includes at least one of beam prediction accuracy (e.g., beam
  prediction accuracy (%) for top K (K >= 1) beams or with 1Db margin for top 1 beam,
  average value or CDF of L1-RSRP/L1-SINR difference of top 1 predicted beam),
  system performance (e.g., throughput, RS overhead reduction), reporting overhead
  reduction, latency reduction, power consumption reduction, model complexity,
  computational complexity.
✓ The report content for model selection may includes multiple Report contents listed
  in Model monitoring.
```

Table 5 shows temporal beam prediction with NE-side model.

TABLE 5

| | | Model |
|---|---|---|
| Model inference | Model monitoring | training/update |
| Beam IDs and (or) measured | Report contents listed in Model | Report contents |
| beam qualities of all beams in | inference | listed in Model |
| Set B(s) in K time instance(s) | Beam IDs and (or) measured | inference |
| Indication(s) of Set B(s) in K | beam qualities of all beams in | Beam IDs and (or) |
| time instance(s) | Set A in F time instance(s) | measured beam |
| Indication of number of beams | Beam IDs and (or) measured | qualities of all |
| reported in the CSI report | beam qualities of top N beams in | beams in Set A in F |
| Indication of model (e.g., model | Set A in F time instance(s) | time instance(s) |
| ID), model list or functionality | Beam IDs and (or) measured | Beam IDs and (or) |
| Assistance information (in K | beam qualities of all beams in | measured beam |
| time instance(s)) | Set B(s) in F time instance(s) (if | qualities of all |
| Measured CSI/beam in K time | Set B(s) in K time instance(s) are | beams in Set A in K |
| instances | the same) | time instance(s) |
| | Indication(s) of Set B(s) in F | |
| | time instance(s) | |
| | Indication of number of beams | |
| | reported in the CSI report | |

```
✓ Set B can be a subset of Set A, be the same as Set A, or be different from Set A.
✓ K is an integer larger than or equal to 1. And the K time instance(s) may occur during
  a measurement time window corresponding to the input of the AI/ML model.
✓ F is an integer larger than or equal to 1. And the F time instance(s) may occur during
  a prediction time window corresponding to the output of the AI/ML model.
✓ The report content for model selection may includes multiple Report contents listed
  in Model monitoring.
```

Table 6 shows temporal beam prediction with UE-side model.

TABLE 6

| | Model monitoring | | | | |
|---|---|---|---|---|---|
| Model | UE-side | NW-side | Hybrid | Model training/update | |
| inference | monitoring | monitoring | monitoring | UE-side | NW-side |
| Beam | Indication of | Report | Perfor- | Indication of | Beam |
| IDs/ | disabling or | contents | mance | completion/ | IDs/angles |
| angles | deactivating | listed in | metric | incompletion of | and (or) |
| (or) | AI/ML function | Model | Indication | data collect/ | measured |
| predicted | (e.g., spatial | inference | of | model training/ | beam |
| beam | beam prediction) | Beam | indicating | model update | qualitites |
| qualities | or model (e.g., | IDs/angles | whether | Indication of | of all |
| of top N | current model | and (or) | the | retransmission/ | beams in |
| predicted | Indication of | measured | perfor- | continue | Set A in F |
| beams(s) | model (e.g., new | beam | mance | transmission of | time |
| in Set A | model different | qualitites | metric | data/RS | instance(s) |
| in F time | from the current | of all | satisfies | Indication of model | Beam |
| instance(s) | model) to | beams in | some | (e.g., model ID), | IDs/angles |
| Other | switch/activate/ | Set A in F | pre- | model parameters | and (or) |
| informa- | select | time | defined | or functionality of | measured |
| tion (in F | Indication of | instance(s) | conditions | the trained/updated | qualitites |
| time | information | Beam | or | model | of top N |
| instance | related to input | IDs/angle | thresholds | Indication of | beams(s) |
| (s)) | and (or) output | s and (or) | | to input and (or) | in Set A |
| | of model to | measured | | output of the | in F time |
| | switch/activate/ | qualities | | trained/ | instance(s) |
| | select | of top N | | updated model | Beam |
| | Indication of | beam(s) | | Indication | IDs/angles |
| | scenario/ | in Set A | | scenario/ | and (or) |
| | configuration | in F time | | configuration | measured |
| | applicable | instance(s) | | applicable to | beam |
| | to the | Beam | | model to | qualities |
| | trained/updated | IDs/angles | | switch/activate/ | of all |
| | model | and (or) | | select | beams in |
| | | measured | | | Set A in |
| | | beam | | | K time |
| | | qualities | | | instance(s) |
| | | of all | | | Beam |
| | | beams in | | | IDs/angles |
| | | Set B in F | | | and (or) |
| | | time | | | measured |
| | | instance(s) | | | qualities |
| | | Beam | | | of all |
| | | IDs/angles | | | beam(s) |
| | | and (or) | | | in Set |
| | | measured | | | B(s) in K |
| | | qualities | | | time |
| | | of top N | | | instance(s) |
| | | beam(s) | | | Indication(s) |
| | | in Set B | | | of Set B(s) |
| | | in F time | | | in K time |
| | | instance(s) | | | instance(s) |
| | | indication(s) | | | Indication |
| | | of Set B(s) | | | of number |
| | | in F time | | | of beams |
| | | instance(s) | | | reported |
| | | Indication | | | in the CSI |
| | | of | | | report |
| | | number | | | Indication |
| | | of beams | | | of model |
| | | reported | | | (e.g., model |
| | | in the CSI | | | ID), |
| | | report | | | model list |
| | | Indication | | | or |
| | | of model | | | functiona- |
| | | (e.g., | | | lity |
| | | model | | | Assistance |
| | | ID), | | | 25 |
| | | model list | | | nformation |
| | | or | | | (in K time |
| | | functiona- | | | instance(s)) |
| | | lity | | | |

```
✓ Other information includes at least one of probability for the beam to be the best
  beam, or associated confidence for the beam to be the best beam, beam application
  time/dwelling time, predicted beam failure.
✓ Information related to input/output includes at least one of type/format/size of the
  input/output (e.g., beam pattern or beam IDs corresponding to the beams in Set B or
  Set A), measurement/prediction time window and time interval corresponding to the
  input/output.
✓ The report content for model selection may includes multiple Report contents listed
  in Model monitoring.
```

Alternatively, or in addition, the first type of information may include LCM related information. In some embodiments, the LCM related information may include a LCM component. For example, the LCM component may include one or more of: data collection, model training, model update, model inference, model monitoring, or model selection. Alternatively, or in addition, the LCM related information may include a sub component of LCM component. For example, the sub component of LCM component may include at least one of: data collection in model inference (i.e., data collection required for input of the AI/ML model), reporting inference results in model inference (i.e., reporting output data from the AI/ML model), data collection in model monitoring, reporting monitoring results in model monitoring (for example, an indication of at least one of the followings: model deactivation, model switch, model reselection or fallback), reporting decision results, data collection in model training, reporting training results in model training, data collection in model update, or reporting training or update results in model update. Table 7 below shows examples of sub components.

TABLE 7

| | Model inference | Model monitoring/selection | Model training/update |
|---|---|---|---|
| Sub com- | Collect/report | Collect/report data required | Collect/report data |
| ponent of | data required for | for model monitoring/ | required for model |
| LCM | input of AI/ML | selection, e.g., data required | training/update, e.g., |
| component | model | for input of AI/ML model, | data and labels |
| | Report predicted | predicted results (i.e., output | required for input and |
| | results (i.e., out- | of AI/ML model) | output of AI/ML |
| | put of AI/ML | Report monitoring results, | model |
| | model) | e.g., performance metric, | Report results of |
| | | indication of indicating | model training/ |
| | | whether the performance | update, e.g., indication |
| | | metric satisfies some | of indicating whether |
| | | predefined conditions | model training/update |
| | | or thresholds | is completed, the |
| | | Report decisions, e.g., | trained/updated |
| | | indication of fallback to | model (reference to |
| | | non-AI/ML, | Table 1, Table 2, |
| | | model deactivation/ | Table 4 or Table 6) |
| | | activation/switching/ | |
| | | selection/update | |
| | | (reference to Table 1, | |
| | | Table 2, Table 4 or Table 6) | |

The first type of information may also include model related information. For example, the model related information may include one or more of: a format of input of an AI/ML model, a type of input of the AI/ML model, a size of input of the AI/ML model, a format of output of the AI/ML model, a type of output of the AI/ML model, or a size of output of the AI/ML model. The model related information may include at least one of: a quantization method associated with the AI/ML model, a dequantization method associated with the AI/ML model, or a codedbook associated with the AI/ML model, for example, type of quantization/dequantization method/codebook, size of quantized bits.

In some embodiments, the model related information may indicate an identity of the AI/ML model. By way of example, the model related information may include an indication of the AI/ML model, for example, model ID. Alternatively, or in addition, the model related information may indicate a list of AI/ML models. By way of example, the model related information may include an indication of the list of AI/ML models, for example, model list or group ID.

In some other embodiments, the model related information may indicate functionality corresponding to the AI/ML model. By way of example, the model related information may include an indication of functionality corresponding to the model, for example, functionality ID, functionality list or group ID.

Alternatively, or in addition, the model related information may indicate a dataset associated with the AI/ML mode. By way of example, the model related information may indicate an indication of the dataset, for example, a dataset ID. In some embodiments, the model related information may indicate a scenario applicable to the AI/ML mode. By way of example, the model related information may include an indication of the scenario, for example, scenario ID. In some other embodiments, the model related information may indicate a configuration applicable to the AI/ML model. By way of example, the model related information may include an indication of the configuration, for example, configuration ID. In some embodiments, the model related information may indicate a site applicable to the AI/ML model. By way of example, the model related information may include an indication of the side, for example, side ID. The model related information may indicate a cell applicable to the AI/ML mode. By way of example, the model related information may include an indication of the cell, for example, cell ID. In some other embodiments, the model related information may indicate a bandwidth part (BWP) associated with the AI/ML model.

In some embodiments, the model related information may indicate a generalization performance corresponding to the AI/ML model. For example, the model related information may include one or more of: one model having the highest generalization performance (i.e., applicable to multiple scenario/configuration) and multiple models applicable to specific scenario/configuration are deployed/registered/configured for one list of models or one functionality.

Alternatively, or in addition, the model related information may indicate a set of reliabilities corresponding to the AI/ML model. For example, the reliability corresponding to the AI/ML model may include a performance metric. The performance metric may be obtained by model monitoring or selection, for example, shown in Tables 1, 2 and 4. In some embodiments, the reliability corresponding to the AI/ML model may include a number of occurrences of model monitoring before the CSI report associated with the AI/ML model. The CSI report associated with an AI/ML model may mean that the AI/ML model is used for calculating/inferring/predicting the report content (i.e., CSI) included in the CSI report. In some embodiments, the reliability corresponding to the AI/ML model may include a time duration between the CSI report associated with the AI/ML model and a timing of at least one of: model monitoring, model inference, or model activation. The reliability corresponding to the AI/ML model may include a frequency of model monitoring, for example, period of model monitoring. In some embodiments, the reliability corresponding to the AI/ML model may include a source of the AI/ML model, for example, model is obtained by model switching/selection/training (e.g., online/offline training)/update.

In some other embodiments, the first type of information may include CPU related information. The CPU related information may include the number of CPUs corresponding to the CSI report. For example, the number of CPUs corresponding to AI CSI report may refer to number of CPUs occupied by processing or updating the AI CSI report. Alternatively, or in addition, the CPU related information may include time occupied by CPUs corresponding to the CSI report. For example, the time occupied by CPU(s) corresponding to AI CSI report may refer to a number of OFDM symbols occupied by CPU(s) associated with the AI CSI report.

In some embodiments, the terminal device 110 may determine a priority value of the CSI report based on the first type of information and second information. For example, the terminal device 110 may determine a first priority value of the first CSI report based on the first type of information and the second information. The terminal device 110 may determine a second priority value of the second CSI report based on the first type of information and the second information. By way of example, the terminal device 110 may determine priority value based on the formula:

$$Priority value = {A}_{1} \times {a}_{1} + {A}_{2} \times {a}_{2} + ⋯ + {A}_{B - 1} \times {a}_{B - 1} + {A}_{B} \times {a}_{B} , \qquad ( 1 )$$

where a₁, a₂, . . . , a_{B-1}, a_{B} are independent variables of priority values, and A₁, A₂, . . . , A_{B-1}, A_{B} are constants of priority values.

In this embodiment, the parameters similar to “y”, “k”, “c” and “s” may be called as “independent variable of priority value”. The parameters similar to “Ncells” and “Ms” may be called as “constant of priority value”.

In some embodiments, a value of a first independent variable of the first priority value may be determined based on the first type of information. A value of a second independent variable of the second priority value may be determined based on the first type of information. For example, the independent variable of priority value (e.g., reuse “k” or use a new parameter) corresponding to compressed bits can be the same as the independent variable of priority value corresponding to predicted CSI. And the value of independent variable of priority value corresponding to compressed bits can be lower than that of the “independent variable of priority value” corresponding to predicted CSI.

In some embodiments, a value of a first constant of the first priority value may be determined based on the second information and a value of a second constant of the second priority value may be determined based on the second information. For example, the second information may include one or more of: a maximum number of LCM components, or a maximum number of sub components of LCM component. The second information may also include a maximum number of at least one of model related information, for example, maximum number of types of a given model related information. In some embodiments, the second information may include a maximum number of at least one CPU related information, for example, maximum number of types of a given CPU related information. Additionally, value of the last (or lowest) “constant of priority value” (i.e., AB) may be 1. Value of the “B” is determined based on number of the first type of information used for determining the priority value or the independent variable of priority value.

The terminal device 110 determines (2030) a CSI report to be transmitted or updated based on the determined priorities. In this way, the collisions between CSI reports that are generated based on AI/ML models can be solved.

For example, the terminal device 110 may determine the CSI report to be transmitted or updated based on the first priority value and the second priority value. For example, in some embodiments, the terminal device 110 may transmit (2040) the CSI report to the network device 120. By way of example, the CSI report with higher (or the highest) priority value can be dropped. It also means that the CSI report with higher priority value may not be sent. The CSI report(s) with lower (or the lowest) priority value can be sent. Furthermore, a plurality of CSI reports with lower priority rule may be multiplexed and be sent, e.g., the plurality of CSI reports may have the same periodicity.

In some embodiments, the terminal device 110 may determine the priorities of CSI reports based on the first type of information and a predetermined priority rule. For example, the terminal device 110 may determine the CSI report(s) to be updated (i.e., process or update the information carried in the AI CSI report(s)) among the colliding CSI reports based on the determined priority values of the CSI reports. For example, the CSI report with higher (or highest) priority value may not be updated. Alternatively, the CSI report with lower (or lowest) priority value may be updated.

In some embodiments, the terminal device 110 may determine the CSI report(s) to be sent or updated among the colliding CSI reports based on a predefined priority criteria/rule. For example, the predefined priority criteria may include at least one of the following: the priority for sending or updating CSI report of a CSI report associated with the first type of information is higher (or lower) than another AI CSI report associated with a second type of information. The second type of information may be AI/ML related but include different contents from the first type of information. The first type of information is different from the second type information. For example, assuming that the predefined priority criteria is “the priority for sending of an AI CSI report associated with model inference is higher than another AI CSI report associated with model monitoring”, when a CSI report associated with model inference and another CSI report associated with model monitoring collide, the CSI report associated with model inference may be sent. And the CSI report associated with model monitoring may be dropped or may not be sent.

Alternatively, or in addition, the terminal device 110 may determine that a third CSI report and the first and/or second CSI report collide. The third CSI report is a second type of CSI report. In this case, the terminal device 110 may determine a third priority of the third CSI report and the first priority of the first CSI report based on a predetermined criterion. For example, a priority of the first type of CSI report may be higher than that of the second type of CSI report. Alternatively, the priority of the second type of CSI report is lower than that of the second type of CSI report. For example, when one or more AI CSI reports and one or more non-AI CSI reports collide, the terminal device 110 may determine priorities of the AI CSI reports and the non-AI CSI reports based on one of the following criteria/rules: Rule-1: The priority of AI CSI report is lower than that of non-AI CSI report; Rule-2: The priority of AI CSI report is higher than that of non-AI CSI report. It may also mean that, the terminal device 110 can determine AI CSI reports or (and) non-AI CSI reports to be sent or updated/processed among the (colliding) AI CSI reports and the non-AI CSI reports based on one of the above criteria/rules. For example, if Rule-1 is adopted, when one or more AI CSI reports and one or more non-AI CSI reports collide, the AI CSI reports will be dropped (i.e., not be sent) or not be updated/processed. And the terminal device 110 can further determine non-AI CSI report(s) to be sent or updated/processed among the non-AI CSI reports based on the conventional priority rules. For another example, if the terminal device 110 is configured with multiple PUCCH resources that is configured to carry CSI report and the number of PUCCH resources is larger than the number of the colliding non-AI CSI reports, the terminal device 110 can determine AI CSI reports to be sent or updated/processed among the (colliding) AI CSI reports. Then, the (determined) AI CSI reports to be sent or updated/processed and the (colliding) non-AI CSI reports can be multiplexed (and sent).

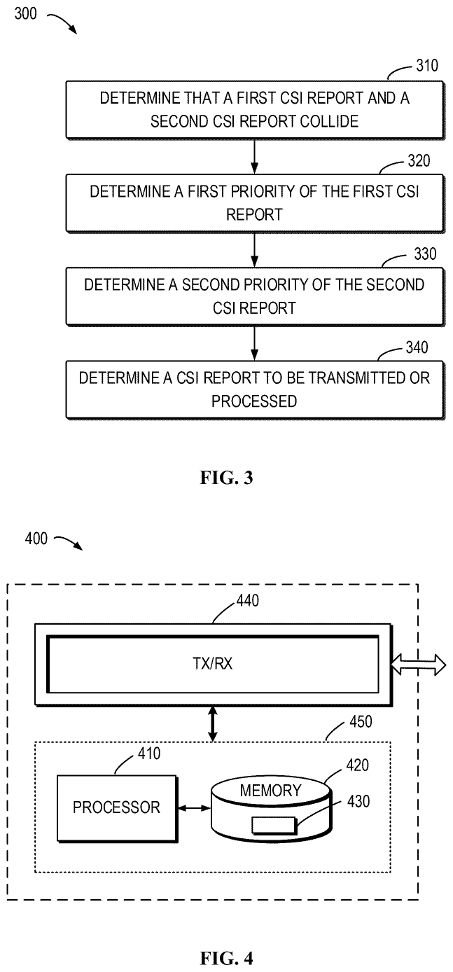

FIG. 3 illustrates a flowchart of a communication method 300 implemented at a terminal device in accordance with some embodiments of the present disclosure. In some embodiments, the method 300 may be implemented by the terminal device 110 in FIG. 1. Alternatively, the method 300 may be implemented by the network device 120 in FIG. 1.

At block 310, the device determines that a first channel state information (CSI) report and a second CSI report collide. The first and second CSI reports are first type of CSI reports.

In some embodiments, the first type of CSI report satisfies at least one of: a type of the first type of CSI report is different from a type of a non-AI CSI report, the first type of CSI report is associated with an AI/ML function or a LCM component, the first type of CSI report is associated with at least one of: AI/ML model information, AI/ML functionality information, a list of AI/ML model information, or a list of AI/ML functionality information, the first type of CSI report is associated with a reference signal (RS) or a RS set that is configured for an AI/ML function or a LCM component, or the first type of CSI report carries the set of AI/ML related report contents. In some embodiments, the first type of CSI report is associated with an AI/ML function or a LCM component comprises at least one of: the first type of CSI report is configured or indicated for the AI/ML function or the LCM component, or the first type of CSI report occurs during a time duration that is configured for the AI/ML function or the LCM component, or the first type of CSI report occurs after the device receives a signaling that enables the AI/ML function or the LCM component.

At block 320, the device determines a first priority of the first CSI report based on first type of information associated with the first CSI report. At block 330, the device determines a second priority of the second CSI report based on the first type of information associated with the second CSI report. The first type of information comprises at least one of: a set of artificial intelligent/machine learning (AI/ML) related report contents, life cycle management (LCM) related information, model related information, or CSI processing unit (CPU) related information.

In some embodiments, the set of AI/ML related report contents comprises at least one of: a set of compressed bits, a first indication of an AI/ML model, a second indication of a functionality, a CSI with a resolution exceeding a threshold, a performance metric, a third indication concerning whether the performance metric satisfies a condition, a fourth indication concerning whether is a training or data collection stage of an AI/ML model completed, a predicted CSI, a fifth indication of at least one of the followings: model deactivation, model activation, model switching, model selection, or fallback, assistance information associated with at least one of: beam or the device, or first information comprises at least one of: a probability for a predicted beam to be the best beam, a confidence level for the predicted beam to be the best beam, a beam application time, a predicted beam failure. In some embodiments, the assistance information associated with at least one of beam or the device comprises at least one of: a receiving beam identity, a receiving beam angle, receiving beam shape information, an identity or angle of an expected receiving beam, position information of the device, direction information of the device, orientation information of the device, or speed information of the device.

In some embodiments, the set of AI/ML related report contents may comprise at least one of: a first set of report contents related to model inference, a second set of report contents related to model monitoring, a third set of report contents related to model training, or a fourth set of report contents related to model update. In some embodiments, the set of AI/ML related report contents comprises at least one of: a fifth set of report contents to be input of an AI/ML model, or a sixth set of report contents to be output of the AI/ML model.

In some embodiments, the LCM related information comprises at least one of: a LCM component, or a sub component of LCM component. For example, the LCM component comprises at least one of: data collection, model training, model update, model inference, model monitoring, or model selection. In some embodiments, the sub component of LCM component comprises at least one of: data collection in model inference, reporting inference results in model inference, data collection in model monitoring, reporting monitoring results in model monitoring, reporting decision results, data collection in model training, reporting training results in model training, data collection in model update, or reporting update results in model update.

In some embodiments, the model related information indicates at least one of: a format of input of an AI/ML model, a type of input of the AI/ML model, a size of input of the AI/ML model, a format of output of the AI/ML model, a type of output of the AI/ML model, a size of output of the AI/ML model, a quantization method associated with the AI/ML model, a codedbook associated with the AI/ML model, an identity of the AI/ML model, a list of AI/ML models, functionality corresponding to the AI/ML model, dataset associated with the AI/ML model, a scenario applicable to the AI/ML model, a configuration applicable to the AI/ML model, a site applicable to the AI/ML model, a cell applicable to the AI/ML model, a bandwidth part (BWP) associated with the AI/ML model, a generalization performance corresponding to the AI/ML model, or a set of reliabilities corresponding to the AI/ML model. In some embodiments, the reliability corresponding to the AI/ML model comprises at least one of: a performance metric, a number of occurrences of model monitoring before a CSI report associated with the AI/ML model, a time duration between the CSI report associated with the AI/ML model and a timing of at least one of: model monitoring, model inference, or model activation, a frequency of model monitoring, or a source of the AI/ML model. In some embodiments, the CPU related information comprises at least one of: a number of CPUs corresponding to the CSI report, or time occupied by CPUs corresponding to the CSI report.

In some embodiments, the device may determine a first priority value of the first CSI report based on the first type of information and second information. In some embodiments, the device may determine a second priority value of the second CSI report based on the first type of information and the second information. In some embodiments, a value of a first independent variable of the first priority value is determined based on the first type of information. In some embodiments, a value of a second independent variable of the second priority value is determined based on the first type of information. In some embodiments, a value of a first constant of the first priority value is determined based on the second information. In some embodiments, a value of a second constant of the second priority value is determined based on the second information. In some embodiments, the second information comprises at least one of: a maximum number of LCM components, a maximum number of sub components of LCM component, a maximum number of at least one of model related information, or a maximum number of at least one CPU related information.

In some embodiments, the device may determine the CSI report to be transmitted or updated based on the first priority value and the second priority value. In some embodiments, the device may determine the first priority of the first CSI report based on the first type of information associated with the first CSI report and a predetermined priority rule. In some embodiments, the device may determine the second priority of the second CSI report based on the second type of information associated with the second CSI report and the predetermined priority rule.

In some embodiments, the predetermined priority rule comprises at least one of: a priority for transmitting the first CSI report associated with the first type of information is higher than that of the second CSI report associated with a second type of information, or the priority for transmitting the first CSI report associated with the first type of information is lower than that of the second CSI report associated with a second type of information.

At block 340, the device determines, from the first and second CSI reports, a CSI report to be transmitted or updated based on the determined first and second priorities.

In some embodiments, the device may determine that a third CSI report and the first CSI report collide, wherein the third CSI report is a second type of CSI report. In some embodiments, the device may determine a third priority of the third CSI report and the first priority of the first CSI report based on a predetermined criterion. In some embodiments, the predetermined criterion comprises one of: a priority of the first type of CSI report is higher than that of the second type of CSI report, or the priority of the second type of CSI report is lower than that of the second type of CSI report.

FIG. 4 is a simplified block diagram of a device 400 that is suitable for implementing embodiments of the present disclosure. The device 400 can be considered as a further example implementation of any of the devices as shown in FIG. 1. Accordingly, the device 400 can be implemented at or as at least a part of the terminal device 110 or the network device 120.

As shown, the device 400 includes a processor 410, a memory 420 coupled to the processor 410, a suitable transmitter (TX)/receiver (RX) 440 coupled to the processor 410, and a communication interface coupled to the TX/RX 440. The memory 410 stores at least a part of a program 430. The TX/RX 440 is for bidirectional communications. The TX/RX 440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 430 is assumed to include program instructions that, when executed by the associated processor 410, enable the device 400 to operate in accordance with the embodiments of the present disclosure, as discussed herein with reference to FIGS. 1 to 3. The embodiments herein may be implemented by computer software executable by the processor 410 of the device 400, or by hardware, or by a combination of software and hardware. The processor 410 may be configured to implement various embodiments of the present disclosure. Furthermore, a combination of the processor 410 and memory 420 may form processing means 450 adapted to implement various embodiments of the present disclosure.

The memory 420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 420 is shown in the device 400, there may be several physically distinct memory modules in the device 400. The processor 410 may be of any type suitable to the local technical network, and may include one or more of general purpose computers, special purpose computers, microprocessors, digital signal processors (DSPs) and processors based on multicore processor architecture, as non-limiting examples. The device 400 may have multiple processors, such as an application specific integrated circuit chip that is slaved in time to a clock which synchronizes the main processor.

In some embodiments, a device comprises a circuitry configured to: determine that a first channel state information (CSI) report and a second CSI report collide, wherein the first and second CSI reports are first type of CSI reports; determine a first priority of the first CSI report based on first type of information associated with the first CSI report; determine a second priority of the second CSI report based on the first type of information associated with the second CSI report, wherein the first type of information comprises at least one of: a set of artificial intelligent/machine learning (AI/ML) related report contents, life cycle management (LCM) related information, model related information, or CSI processing unit (CPU) related information; and determine, from the first and second CSI reports, a CSI report to be transmitted or updated based on the determined first and second priorities.

According to embodiments of the present disclosure, the circuitry may be configured to perform any of the method implemented by the device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a device for communication, comprises a processor, configured to cause the device to: determine that a first channel state information (CSI) report and a second CSI report collide, wherein the first and second CSI reports are first type of CSI reports; determine a first priority of the first CSI report based on first type of information associated with the first CSI report; determine a second priority of the second CSI report based on the first type of information associated with the second CSI report, wherein the first type of information comprises at least one of: a set of artificial intelligent/machine learning (AI/ML) related report contents, life cycle management (LCM) related information, model related information, or CSI processing unit (CPU) related information; and determine, from the first and second CSI reports, a CSI report to be transmitted or updated based on the determined first and second priorities.

In some embodiments, the first type of CSI report satisfies at least one of: a type of the first type of CSI report is different from a type of a non-AI CSI report, the first type of CSI report is associated with an AI/ML function or a LCM component, the first type of CSI report is associated with at least one of: AI/ML model information, AI/ML functionality information, a list of AI/ML model information, or a list of AI/ML functionality information, the first type of CSI report is associated with a reference signal (RS) or a RS set that is configured for an AI/ML function or a LCM component, or the first type of CSI report carries the set of AI/ML related report contents.

In some embodiments, the first type of CSI report is associated with an AI/ML function or a LCM component comprises at least one of: the first type of CSI report is configured or indicated for the AI/ML function or the LCM component, or the first type of CSI report occurs during a time duration that is configured for the AI/ML function or the LCM component, or the first type of CSI report occurs after the device receives a signaling that enables the AI/ML function or the LCM component.

In some embodiments, the set of AI/ML related report contents comprises at least one of: a set of compressed bits, a first indication of an AI/ML model, a second indication of a functionality, a CSI with a resolution exceeding a threshold, a performance metric, a third indication concerning whether the performance metric satisfies a condition, a fourth indication concerning whether is a training or data collection stage of an AI/ML model completed, a predicted CSI, a fifth indication of at least one of the followings: model deactivation, model activation, model switching, model selection, or fallback, assistance information associated with at least one of: beam or the device, or first information comprises at least one of: a probability for a predicted beam to be the best beam, a confidence level for the predicted beam to be the best beam, a beam application time, a predicted beam failure.

In some embodiments, the assistance information associated with at least one of beam or the device comprises at least one of: a receiving beam identity, a receiving beam angle, receiving beam shape information, an identity or angle of an expected receiving beam, position information of the device, direction information of the device, orientation information of the device, or speed information of the device.

In some embodiments, the set of AI/ML related report contents comprises at least one of: a first set of report contents related to model inference, a second set of report contents related to model monitoring, a third set of report contents related to model training, or a fourth set of report contents related to model update.

In some embodiments, the set of AI/ML related report contents comprises at least one of: a fifth set of report contents to be input of an AI/ML model, or a sixth set of report contents to be output of the AI/ML model.

In some embodiments, the LCM related information comprises at least one of: a LCM component, or a sub component of LCM component.

In some embodiments, the LCM component comprises at least one of: data collection, model training, model update, model inference, model monitoring, or model selection.

In some embodiments, the sub component of LCM component comprises at least one of: data collection in model inference, reporting inference results in model inference, data collection in model monitoring, reporting monitoring results in model monitoring, reporting decision results, data collection in model training, reporting training results in model training, data collection in model update, or reporting update results in model update.

In some embodiments, the model related information indicates at least one of: a format of input of an AI/ML model, a type of input of the AI/ML model, a size of input of the AI/ML model, a format of output of the AI/ML model, a type of output of the AI/ML model, a size of output of the AI/ML model, a quantization method associated with the AI/ML model, a codedbook associated with the AI/ML model, an identity of the AI/ML model, a list of AI/ML models, functionality corresponding to the AI/ML model, dataset associated with the AI/ML model, a scenario applicable to the AI/ML model, a configuration applicable to the AI/ML model, a site applicable to the AI/ML model, a cell applicable to the AI/ML model, a bandwidth part (BWP) associated with the AI/ML model, a generalization performance corresponding to the AI/ML model, or a set of reliabilities corresponding to the AI/ML model.

In some embodiments, the set of reliabilities corresponding to the AI/ML model comprises at least one of: a performance metric, a number of occurrences of model monitoring before a CSI report associated with the AI/ML model, a time duration between the CSI report associated with the AI/ML model and a timing of at least one of: model monitoring, model inference, or model activation, a frequency of model monitoring, or a source of the AI/ML model.

In some embodiments, the CPU related information comprises at least one of: a number of CPUs corresponding to the CSI report, or time occupied by CPUs corresponding to the CSI report.

In some embodiments, the processor is further configured to cause the device to: determine a first priority value of the first CSI report based on the first type of information and second information; and wherein the processor is further configured to cause the device to: determine a second priority value of the second CSI report based on the first type of information and the second information.

In some embodiments, a value of a first independent variable of the first priority value is determined based on the first type of information, and wherein a value of a second independent variable of the second priority value is determined based on the first type of information, and wherein a value of a first constant of the first priority value is determined based on the second information, and wherein a value of a second constant of the second priority value is determined based on the second information.

In some embodiments, the second information comprises at least one of: a maximum number of LCM components, a maximum number of sub components of LCM component, a maximum number of at least one of model related information, or a maximum number of at least one CPU related information.

In some embodiments, the processor is further configured to cause the device to: determine the CSI report to be transmitted or updated based on the first priority value and the second priority value.

In some embodiments, the processor is further configured to cause the device to: determine the first priority of the first CSI report based on the first type of information associated with the first CSI report and a predetermined priority rule; and determine the second priority of the second CSI report based on the second type of information associated with the second CSI report and the predetermined priority rule.

In some embodiments, the predetermined priority rule comprises at least one of: a priority for transmitting the first CSI report associated with the first type of information is higher than that of the second CSI report associated with a second type of information, or the priority for transmitting the first CSI report associated with a first type of information is lower than that of the second CSI report associated with a second type of information.

In some embodiments, the process is further configured to cause the device to: determine that a third CSI report and the first CSI report collide, wherein the third CSI report is a second type of CSI report; and determine a third priority of the third CSI report and the first priority of the first CSI report based on a predetermined criterion.

In some embodiments, the predetermined criterion comprises one of: a priority of the first type of CSI report is higher than that of the second type of CSI report, or the priority of the second type of CSI report is lower than that of the second type of CSI report.

In an aspect, a computer readable medium having instructions stored thereon, the instructions, when executed on at least one processor, causing the at least one processor to perform the method implemented by the device discussed above.

In an aspect, a computer program comprising instructions, the instructions, when executed on at least one processor, causing the at least one processor to perform the method implemented by the device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a terminal device, the method comprising:
determining a priority with a first priority value associated with a first channel state information (CSI) content for a CSI report or a second priority value associated with a second CSI content for the CSI report; and
transmitting the CSI report with the priority,
wherein:
the first CSI content comprises at least one of a predicted channel state information reference signal resource indicator (P-CRI), a predicted synchronization signal block resource indicator (P-SSBRI), a predicted layer 1 reference signal received power (P-L1-RSRP), or a reference signal prediction accuracy indicator (RS-PAI),
the second CSI content comprises a CSI prediction accuracy indicator (CSI-PAI), and the second content does not comprise the P-CRI, the P-SSBRI, the P-L1-RSRP or the RS-PAI.

22. The method of claim 21, wherein
the first priority value is lower than the second priority value.

23. A method, performed by a network device, the method comprising:
transmitting a configuration for a channel state information (CSI) report, and
receiving the CSI report with a priority, the priority being with a first priority value associated with a first CSI content for the CSI report or a second priority value associated with a second CSI content for the CSI report,
wherein:
the first CSI content comprises at least one of a predicted channel state information reference signal resource indicator (P-CRI), a predicted synchronization signal block resource indicator (P-SSBRI), a predicted layer 1 reference signal received power (P-L1-RSRP), or a reference signal prediction accuracy indicator (RS-PAI),
the second CSI content comprises a CSI prediction accuracy indicator (CSI-PAI), and the second content does not comprise the P-CRI, the P-SSBRI, the P-L1-RSRP or the RS-PAI.

24. The method of claim 23, wherein
the first priority value is lower than the second priority value.

25. A terminal device, comprising a processor configured to cause the terminal device to:
determine a priority with a first priority value associated with a first channel state information (CSI) content for a CSI report or a second priority value associated with a second CSI content for the CSI report; and
transmit the CSI report with the priority,
wherein:
the first CSI content comprises at least one of a predicted channel state information reference signal resource indicator (P-CRI), a predicted synchronization signal block resource indicator (P-SSBRI), a predicted layer 1 reference signal received power (P-L1-RSRP), or a reference signal prediction accuracy indicator (RS-PAI),
the second CSI content comprises a CSI prediction accuracy indicator (CSI-PAI), and the second content does not comprise the P-CRI, the P-SSBRI, the P-L1-RSRP or the RS-PAI.

26. The terminal device of claim 25, wherein
the first priority value is lower than the second priority value.
